(19) United States
(12) Patent Application Publication
(10) Pub. No.: US 2009/0328092 A1
(43) Pub. Date: Dec. 31, 2009

(54) PERSONALIZING ANY TV GATEWAY

(75) Inventors: Stefan Goeman, Mortsel (BE); Luc Uytterhoeven, Olsen (BE)

Correspondence Address: MICHAEL N. HAYNES, 1341 HUNTERSFIELD CLOSE, KESWICK, VA, 22947, US

(73) Assignee: NOKIA SIEMENS NETWORKS GMBH & CO KG, Munich (DE)

(21) Appl. No.: 12/439,996

(22) PCT Filed: Aug. 24, 2007
(86) PCT No.: PCT/EP07/07466

§ 371 Date: May 18, 2009

(30) Foreign Application Priority Data
Sep. 4, 2006 (EP) 06018502.2

(51) Int. Cl. H04N 7/16; G06F 7/04

(52) U.S. Cl. 725/25; 340/5.6; 725/82

(57) ABSTRACT

A system and method for personalizing a TV gateway is disclosed. Specifically, the disclosed system includes a TV gateway authentication infrastructure and a user authentication infrastructure in communication with external networks. The TV gateway authentication infrastructure accesses the external networks and authenticates the TV gateway. The user authentication infrastructure authenticates an end-user via end-user credentials contained in a personal tamper resistant device, which is in communication with the TV gateway. When an end-user is authenticated, an end-user profile containing TV service credentials is loaded on the TV gateway enabling the fruition of authorized end-user TV content on a TV display.

### PRIORITY CLAIM

This application is a national stage application of PCT/EP2007/007466, filed Aug. 24, 2007, which claims the benefit of priority to European Application No. 06018502.2, filed Sep. 4, 2006, the contents of which are hereby incorporated by reference.

### TECHNICAL FIELD

The present disclosure relates to a system and method for personalizing a TV gateway of a digital TV system.

### BACKGROUND

Tamper resistant devices typically offer physical protection to electronic keys residing inside them, thus, providing some assurance that these keys have not been maliciously read or modified. Typically, gaining access to the contents of a tamper-resistant device requires knowledge of a PIN or password. The specific type of access that can be gained with knowledge of a PIN or password is typically device-dependent.

In digital television, a device that receives digital media streams containing TV content is, in this context, denoted as a TV gateway.

Typical examples of TV gateways are set top boxes, home gateways, and residential gateways. The TV gateway is typically a shared device, meaning that there is typically only one TV gateway in a household.

An issue in providing digital television service is parental control, e.g., the capability of enabling parents to control the content their children watch.

Various methods of personalizing the TV gateways to provide parental control capabilities have been introduced. The TV gateway personalization process may be compared to the login process on PCs.

Methods for personalizing the TV gateway typically include providing security credentials to the TV gateway for identifying the end-users, e.g., parents may be defined as “super users” with more privileges than their children, who may be defined as “normal users”.

Current TV gateways are typically coupled to a particular household, meaning that members of that household have security credentials to personalize the devices.

A drawback is that other persons, e.g., other family relatives or neighbors, are unable to use and to personalize the TV gateway of that particular household.

Currently, personalization of a TV gateway is typically performed by providing every member of a household with a PIN.

However, the use of the PIN to personalize a specific TV gateway has a drawback that only members of a specific household are able to use and personalize the specific TV gateway.

### SUMMARY

Therefore, there is a need to overcome the above mentioned drawbacks, in particular by providing a method and a system for personalizing a TV gateway in a secure way.

More specifically, a method and system for personalizing a TV gateway of a digital TV system comprising a TV gateway, a TV display connectable to the TV gateway, the TV gateway being connected to external networks, a TV gateway authentication infrastructure is in communication with the external networks and a user authentication infrastructure is in communication with the external networks; and the method includes:
a) by the TV gateway authentication infrastructure, authenticating the TV gateway accessing the external networks;
b) by the user authentication infrastructure, authenticating the end-user via end-user credentials contained in a personal tamper resistant device (TRD) in communication with the TV gateway;
c) if the end-user is authenticated, loading the end-user profile on the TV-gateway;
d) by the TV gateway, enabling the fruition of authorized end-user TV content on the TV display, by using TV service credentials contained in the loaded end-user profile.

The disclosed system and method provides that item a) may be preferably achieved via gateway specific credentials.

The disclosed system and method provides that item b) may advantageously be achieved via end-user specific credentials stored on a tamper resistant device.

The disclosed system and method provides that the personal tamper resistant device may conveniently be in wired communication with the TV gateway via a reader integrated within the TV gateway or may be in wireless communication via a reader external to the TV gateway.

The disclosed system and method provides that the TV gateway may preferably be selected from a group consisting of:
set top boxes;
home gateways; and
residential gateways.

The disclosed system and method provides that the personal tamper resistant device may conveniently be selected from a group consisting of:
smart cards;
SIM cards;
USIM cards;
electronic ID cards; and
social security cards.

According to a preferred embodiment of the disclosed system and method, the digital TV system includes a TV gateway authentication infrastructure and/or a user authentication infrastructure and/or external networks.

The disclosed system and method enables a TV gateway to be personalized according to an end-user identity.

The disclosed system and method decouples the authentication process of the TV gateway from the authentication process of the end-user.

The disclosed system and method is secure and user-friendly. Using a tamper resistant device as taught in the presently disclosed system and method provides more security than a system using PIN numbers alone, e.g., where a child may obtain his/her parents' PIN number.

### BRIEF DESCRIPTION OF THE DRAWINGS

Further details, characteristics, and advantages of the disclosed system and method will become apparent from the following description of preferred but not exclusive embodiments, given by way of non-limiting examples with reference to the accompanying drawing.

FIG. 1 illustrates a block diagram of an example embodiment of the disclosed system.

### DETAILED DESCRIPTION OF EXEMPLARY EMBODIMENTS

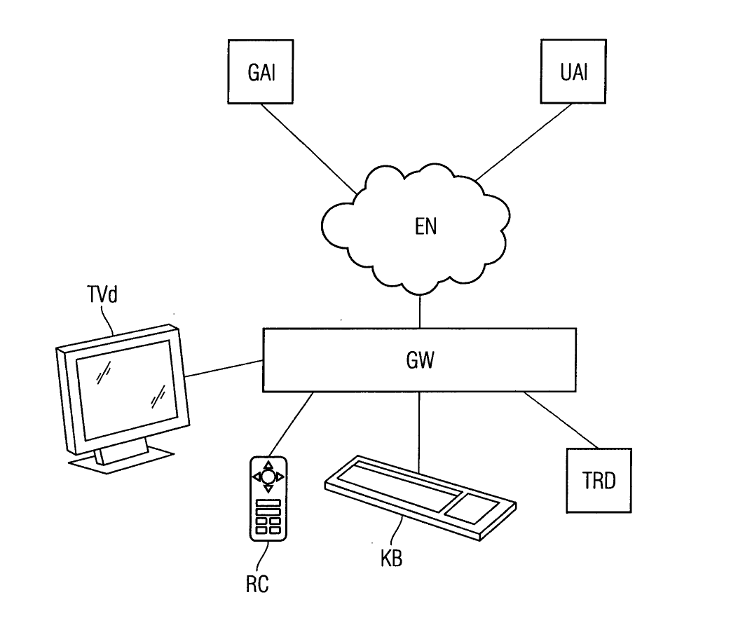

FIG. 1 illustrates an example embodiment of a digital TV display TVd connected to a TV gateway GW. The TV gateway GW may be controlled by a keyboard KB and/or by a remote control device RC. A personal tamper resistant device TRD is used for authenticating the user who is accessing the TV gateway GW.

The personal tamper resistant device TRD may be a personal electronic smart card delivered by a TV service provider to an end-user subscribing to a TV service bundle. In an embodiment, the personal tamper resistant device TRD may be a personal electronic card already in the possession of an end-user, e.g., SIM/USIM cards or electronic ID cards, which are being introduced in several European countries, or social security cards which are used in the United States.

The TV gateway GW may have a reader device for accessing the personal tamper resistant device TRD. In an embodiment, when the personal tamper resistant devices are SIM/USIM cards, the TV gateway may have a Bluetooth interface for accessing the SIM/USIM card in a mobile phone of the end-user.

In an example embodiment using SIM/USIM cards, end-user authentication is based on the fact that such cards belong to the end-user rather than the TV gateway. Moreover, the end-user authentication is based on a long term secret shared between the mobile operator and the end-user. More specifically, for USIM cards, the authentication protocols used are defined in 3GPP industry specifications.

In an example embodiment using electronic smart cards, security credentials present on the electronic smart cards are typically in the form of public-private key pairs. Thus, when the personal tamper resistant device TRD contains a public-private key pair, the TV gateway GW has access at the public key and, the security calculations related to the private key take place on the tamper resistant device TRD.

The type of connections between the TV gateway GW and the tamper resistant device TRD may differ depending on the specific tamper resistant device TRD used with the disclosed system. Depending on the specific tamper resistant device TRD used, reader devices may be external and/or internal to the TV gateway GW.

For example, for smart cards, the card reader may be internally integrated in the TV gateway GW. In an embodiment using SIM/USIM cards, the card reader may be external, e.g., integrated in a mobile phone device. In such a case, the connection between the TV gateway GW and the card reader may be a wireless connection, e.g., a Bluetooth connection.

In an example embodiment, the TV gateway GW is connected to the outside world via different external networks EN, e.g., an IP network for receiving digitized video signals and/or a general IP link to an operator network. In further example embodiments, combinations of IP networks and DVB networks EN are also possible. For example, the DVB network EN may be used for receiving digitized video signals. The IP link EN may provide a connection to the operator network. The IP link may be used to authenticate the TV gateway GW and used for authentication of an end-user.

FIG. 1 illustrates two different example authentication infrastructures, e.g., the TV gateway authentication infrastructure GAI and the end-user authentication infrastructure UAI. According to the present disclosure, the authentication of the TV gateway GW and the authentication of the end-user may be handled separately.

A role of a TV gateway authentication infrastructure GAI is to indicate to the external networks EN, e.g., an IP network of an ISP, that the TV gateway GW is a legitimate device that is allowed to access to the external networks EN.

A TV gateway authentication infrastructure GAI typically includes the infrastructure and protocols required for the authentication of the TV gateways GW. Typically, the TV gateway authentication infrastructure protocols run in lower networking protocol layers, directly on top of link layer protocols, e.g., EAPOL in WLAN, or on top of IP such as IPsec protocol.

In order to be authenticated, the TV gateway GW is provided with proper gateway-dependant security credentials. The type of gateway-dependant security credentials used typically depends on the type of authentication protocol and on underlying network security that may or may not already be present, e.g., security by wire or reduced security by wireless.

The gateway-dependant security credentials are typically stored within a TV gateway GW in a secure and tamper resistant manner to avoid hackers cracking the TV gateway GW and retrieving the TV gateway's security credentials.

In an embodiment, gateway-dependant security credentials may be stored externally from the TV gateway GW in an ad-hoc tamper resistant device to be inserted within a specific gateway reader.

Examples of TV gateway authentication infrastructure protocols include EAP protocols that allow a variety of different type of authentication mechanisms including CHAP and AKA, which are used in EAP-CHAP and EAP-AKA respectively.

Other examples of TV gateway authentication infrastructure protocols include IPsec protocol. IPsec protocol provides security on top of the IP protocol for authenticating the TV gateway GW with the external network EN and for establishing a secure connection between the TV gateway and the external network EN. IPsec protocol supports several authentication protocols using different types of credentials. An authentication protocol in the IPsec suite is IKE protocol.

Typically, TV gateway authentication may be based on: i) shared secret keys between two authenticating parties; ii) public-private key pairs (e.g., using X.509 certificates) or iii) using specific EAP authentication mechanisms such as CHAP or AKA.

A role of an end-user authentication infrastructure UAI is to authenticate an end-user. Consequently, after end-user authentication, the end-user is able to utilize his/her TV service bundle, e.g., the personalized TV services the end-user ordered.

An end-user authentication process is typically based on the end-user's personal tamper resistant device TRD, which contains the security credentials to be used for the end-user's authentication. As discussed above, end-user authentication may be based on private-public key technology.

A User Authentication Infrastructure UAI may authenticate the end-user after the TV gateway has already been authenticated.

Typically, protocols used for user authentication are application layer protocols and the protocols run in higher protocol layers, e.g., TLS protocol used to secure HTTP traffic.

In order to be authenticated, an end-user is typically provided with end-user security credentials contained in the end-user's personal tamper resistant device TRD. The types of end-user credentials used may depend on the authentication protocol types and on the underlying security, which may or may not already be present. Examples of end-user security credentials include public-private key pairs on smart cards and secret key based credentials on SIM/USIM cards.

In an example embodiment using public-private key pairs, the private key may be stored in a non-volatile secured storage space on the tamper resistant device TRD. User authentication protocols based on private-public key pairs typically provide knowledge of the private key rather than the private key, and provide the certificate to the authenticating party, and are typically more secure than protocols based on user name and password credentials.

An end-user, chooses his/her personalized TV service bundle by subscribing to a digital TV service provider and chooses the TV services he/she wishes to subscribe to. For example, the end-user chooses desired TV channels and, for VoD service, the desired movie types. The choice of TV services subscribed to may be done directly through the service provider or autonomously via remote control RC or keyboard KB prior to insertion of the personal tamper resistant device TRD. The end-user may receive his/her personal tamper resistant device TRD from the TV service provider or may use a personal tamper resistant device TRD already in his/her possession, e.g., a smart ID-card. An end-user who is a parent may wish to limit access possibilities to his/her children, e.g., preventing access to certain TV channels and/or to certain VoD content such as adult movies. The example parent may receive two types of user credentials, e.g., one for parents and one for children, stored on the respective personal tamper resistant devices TRD. In another embodiment, each person in a household may have a personal tamper resistant device TRD.

Thus, according to the present disclosure, parent control may be achieved by providing a child with his/her own personal tamper resistant device TRD, which is different from the parents' tamper resistant device TRD. A typical personal tamper resistant device TRD may allow the authentication of a particular end-user and be associated with an end-user profile describing, for example, the TV content the particular user is enabled to access.

The procedure of personalizing an end-user's TV service bundle may be performed by the end-user by direct interaction with the TV service provider, e.g., by phone. In another embodiment, the end-user may select a preferred TV service bundle through the TV gateway GW via the controlling devices, e.g., keyboard KB and remote control RC. In the latter case, the end-user may authenticate herself via her personal tamper resistant device TRD. During the end-user authentication, the TV gateway GW is “loaded” with an end-user profile received from the external networks EN.

An end-user, in order to enjoy the TV content he has subscribed to, is typically required to authenticate himself via his personal tamper resistant device TRD. The reader of the TV gateway GW accesses the personal tamper resistant device TRD of the end-user through a connection with the user authentication infrastructure UAI, and the end-user is authenticated by the user authentication infrastructure UAI. Before the end-user authentication takes place, the TV gateway GW is authenticated by the gateway authentication infrastructure GAI.

After a positive end-user authentication, the TV gateway GW is typically loaded, in a pull or push manner, with profile information of the specific end-user, which may be stored within the user authentication infrastructure UAI. For example, the end-user profile information includes details on TV services the end-user is authorized to utilize, e.g., TV channels and VoD items, and necessary security credentials for the authorized TV services, e.g., channel decryption keys.

Loading a TV gateway GW with an end-user personal profile typically provides the TV gateway GW with access to TV services the specific end-user is authorized to access. The TV gateway GW may be unable to access any other content because security credentials necessary to access other content are not included in the end-users profile, in which case, the other content may not be available to download to the TV gateway during the end-user authentication process.

Thus, in the disclosed system and method, the TV gateway may be personalized with a specific TV service bundle in accordance with specific authorization of a specific accessing end-user.

The disclosed system and method allows fruition of TV content on the TV display TVd in a secure manner. Advantageously, a neighbor or relative of the household owner is enabled to access and enjoy his own TV content by accessing the TV gateway GW of the household owner and by authenticating himself via his personal tamper resistant device TRD.

It should be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### LIST OF ACRONYMS

### 3GPP 3RD GENERATION PARTNERSHIP PROJECT

### AiCA Authentication and Key Agreement

### CHAP Challenge Handshake Authentication Protocol DVB Digital Video Broadcasting

EAP extended authentication protocol
EAPOL EAP over LAN

### ID IDentification

### IKE Internet Key Establishment

### ISP Internet Service Provider

### IP Internet Protocol

### IPsec IP Security

### LAN Local Area Network

### PC Personal Computer PKI Public Key Infrastructure

### PIN Personal Identification Number

### SIM Subscriber Identity Module

### TLS Transport Layer Security

### TV Television USIM Universal Subscriber Identity Module

### VoD Video on Demand

### WLAN Wireless Local Area Network

### LIST OF REFERENCE SIGNS

GAI TV gateway authentication infrastructure GW TV gateway
EN external network
KB keyboard
RC remote control
TRD tamper resistant device
TVd digital TV display
UAI user authentication infrastructure

What is claimed is:

1. A method for personalizing a TV gateway of a digital TV system, the digital TV system including the TV gateway, which is connected to external networks, a TV display connectable to the TV gateway, and a TV gateway authentication infrastructure and a user authentication infrastructure in communication with the external networks, the method comprising:
a) authenticating the TV gateway by the TV gateway authentication infrastructure accessing the external networks;
b) authenticating an end-user via end-user credentials contained in a personal tamper resistant device in communication with the TV gateway by the user authentication infrastructure;
c) loading an end-user profile on the TV gateway as a result of the end-user being authenticated;
d) enabling the fruition of authorized end-user TV content on the TV display, by the TV gateway using TV service credentials contained in the end-user profile.

2. The method according to claim 1, wherein step a is achieved via gateway specific credentials.

3. The method according to claim 1, wherein step b is achieved via end-user specific credentials stored on a tamper resistant device.

4. The method according to claim 1, wherein the personal tamper resistant device is at least one of (i) in wired communication with the TV gateway via a reader integrated within the TV gateway and (ii) in wireless communication with the TV gateway via a reader external to the TV gateway.

5. The method according to claim 1, wherein the TV gateway is selected from a group consisting of:
set top boxes;
home gateways; and
residential gateways.

6. The method according to claim 1, wherein the personal tamper resistant device is selected from a group consisting of:
smart cards;
SIM cards;
USIM cards;
electronic ID cards; and
social security cards.

7. An apparatus for personalizing a TV gateway of a digital TV system, comprising:
a TV gateway authentication infrastructure in communication with the external networks, the TV gateway authentication infrastructure accessing the external networks and authenticating the TV gateway, which is connected to the external networks:
a user authentication infrastructure in communication with the external networks, the user authentication infrastructure including a personal tamper resistant device in communication with the TV gateway, the personal tamper resistant device authenticating an end-user via end-user credentials contained in the personal tamper resistant device at a first time;
an end-user profile, the end-user profile loadable after the first time onto the TV gateway; and
a TV display connectable to the TV gateway, the TV display enabling the fruition of authorized end-user TV content on the TV display by the TV gateway using TV service credentials contained in the end-user profile.

8. The apparatus of claim 7, wherein the gateway authentication infrastructure uses gateway specific credentials.

9. The apparatus of claim 7, wherein the personal tamper resistant device stores end-user specific credentials.

10. The apparatus of claim 7, wherein the personal tamper resistant device is at least one of (i) in wired communication with the TV gateway via a reader integrated within the TV gateway and (ii) in wireless communication with the TV gateway via a reader external to the TV gateway.

11. The apparatus of claim 7, wherein the TV gateway is selected from a group consisting of:
set top boxes;
home gateways; and
residential gateways.

12. The apparatus of claim 7, wherein the personal tamper resistant device is selected from a group consisting of:
smart cards;
SIM cards;
USIM cards;
electronic ID cards; and
social security cards.
